(19) United States
(12) Patent Application Publication
(10) Pub. No.: US 2026/0131749 A1
(43) Pub. Date: May 14, 2026

(54) BUMPER INCLUDING NON-LINEAR SPRING

(71) Applicant: Ford Global Technologies, LLC, Dearborn, MI (US)

(72) Inventors: Mohammad Omar Faruque, Ann Arbor, MI (US); S.M. Iskander Farooq, Novi, MI (US)

(73) Assignee: Ford Global Technologies, LLC, Dearborn, MI (US)

(21) Appl. No.: 18/946,150

(22) Filed: Nov. 13, 2024

(51) Int. Cl. B60R 19/28

(52) U.S. Cl. CPC B60R 19/28

(57) ABSTRACT

A vehicle includes a vehicle frame having a frame-rail end. The frame-rail end has a vehicle-forward face and a vehicle-rearward face. The vehicle includes a bumper vehicle-forward of the frame-rail end. A rod supports the bumper on the frame-rail end. The rod is fixed to the bumper and slidably extends through the vehicle-forward face and the vehicle-rearward face of the frame-rail end. A head is fixed to the rod and is retained vehicle-rearward of the vehicle-rearward face by the frame-rail end. A spring is on the rod. The spring has a non-linear spring rate.

### BACKGROUND

The Global Technology Regulation (GTR) and the New Car Assessment Program (NCAP) specify leg-injury criteria for pedestrian protection. The regulations are aimed at reducing the impact force to the legs of a pedestrian by a vehicle bumper during a vehicle-pedestrian impact. Standardized tests, including those from the National Highway Traffic Safety Administration (NHTSA), also exist for frontal impact.

Some vehicles, such as light duty trucks and sport utility vehicles (SUVs), for example, may have a bumper height that could lead to an uneven impact on the femur and/or tibia of the pedestrian by the vehicle bumper during the vehicle-pedestrian impact. For example, light duty trucks may have bumper heights to provide ground clearance to clear speed bumps, curbs, parking blocks, inclined driveway ramps, hills, rough roads, etc. Some vehicles with such bumper heights also have off-road capabilities that preclude having any components below the bumper. As such, there is an opportunity to design a vehicle front-end for pedestrian leg impact energy management while addressing ground clearance requirements.

### BRIEF DESCRIPTION OF THE DRAWINGS

FIG. 1 is a perspective view of a portion of a vehicle including a bumper and a vehicle frame shown in broken lines.

FIG. 2 is an exploded view of a portion of the vehicle.

FIG. 3 is a perspective view of a vehicle-rearward side of a portion of the bumper with one example of springs.

FIG. 4 is an exploded view of the bumper and a frame-rail end of FIG. 3.

FIG. 5A is a top view of the bumper in an extended position.

FIG. 5B is a top view of the bumper in a compressed position.

FIG. 5C is a top view of the bumper further compressed with plastic deformation of springs.

FIG. 6 is a perspective view of a vehicle-rearward side of a portion of the bumper with another example of springs.

FIG. 7A is a top view of the bumper in an extended position.

FIG. 7B is a top view of the bumper in a compressed position.

FIG. 8 is a perspective view of a vehicle-rearward side of a portion of the bumper with a latch.

FIG. 9A is a side view of the frame-rail end with the latch in a locked position.

FIG. 9B is a side view of the frame-rail end with the latch in an unlocked position.

FIG. 10 is an example force-deflection curve of a progressive non-linear spring.

### DETAILED DESCRIPTION

With reference to the Figures, wherein like numerals indicate like parts throughout the several views, a vehicle 10 includes a vehicle frame 12 having a frame-rail end 14. The frame-rail end 14 has a vehicle-forward face 16 and a vehicle-rearward face 18. The vehicle 10 includes a bumper 20 vehicle-forward of the frame-rail end 14. A rod 22 supports the bumper 20 on the frame-rail end 14. The rod 22 is fixed to the bumper 20 and slidably extends through the vehicle-forward face 16 and the vehicle-rearward face 18 of the frame-rail end 14. A head 24 is fixed to the rod 22 and is retained vehicle-rearward of the vehicle-rearward face 18 by the frame-rail end 14. A spring 26, 126 is on the rod 22. The spring 26, 126 has a progressive non-linear spring rate.

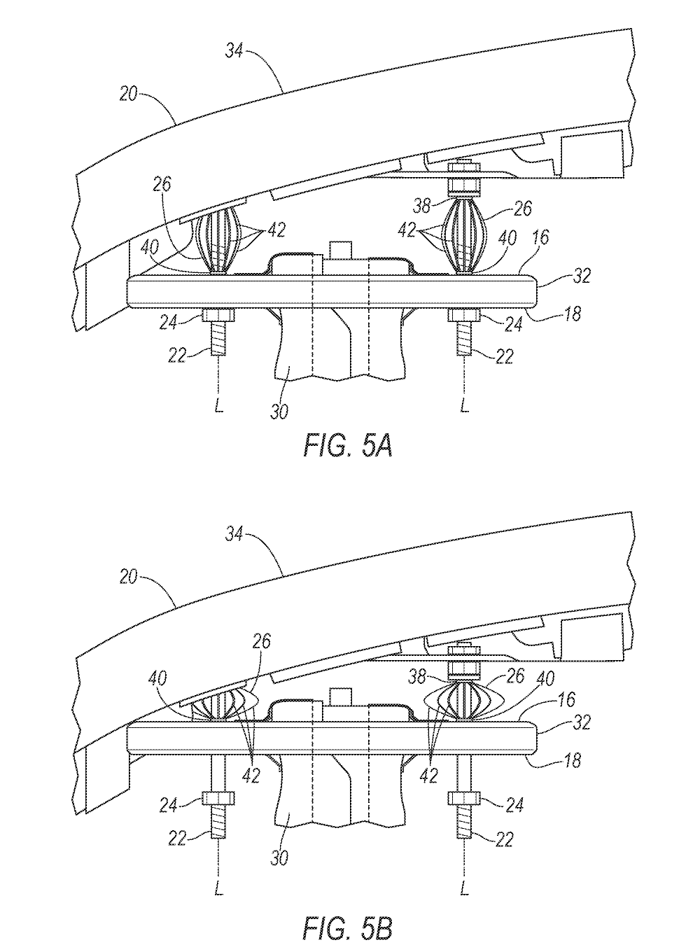

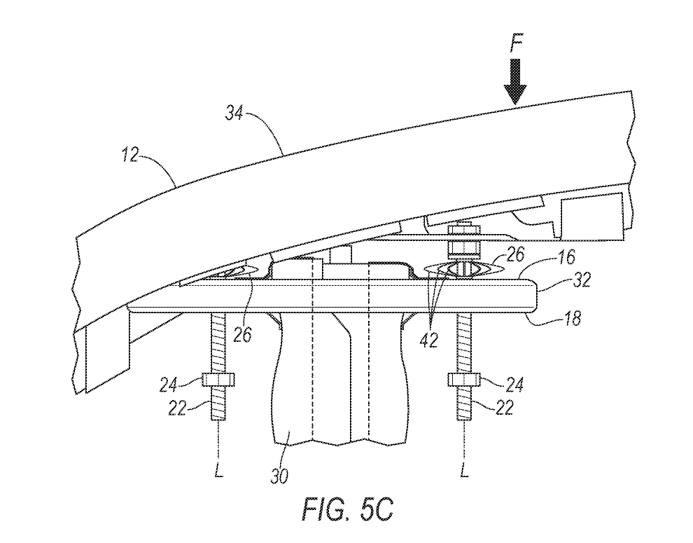

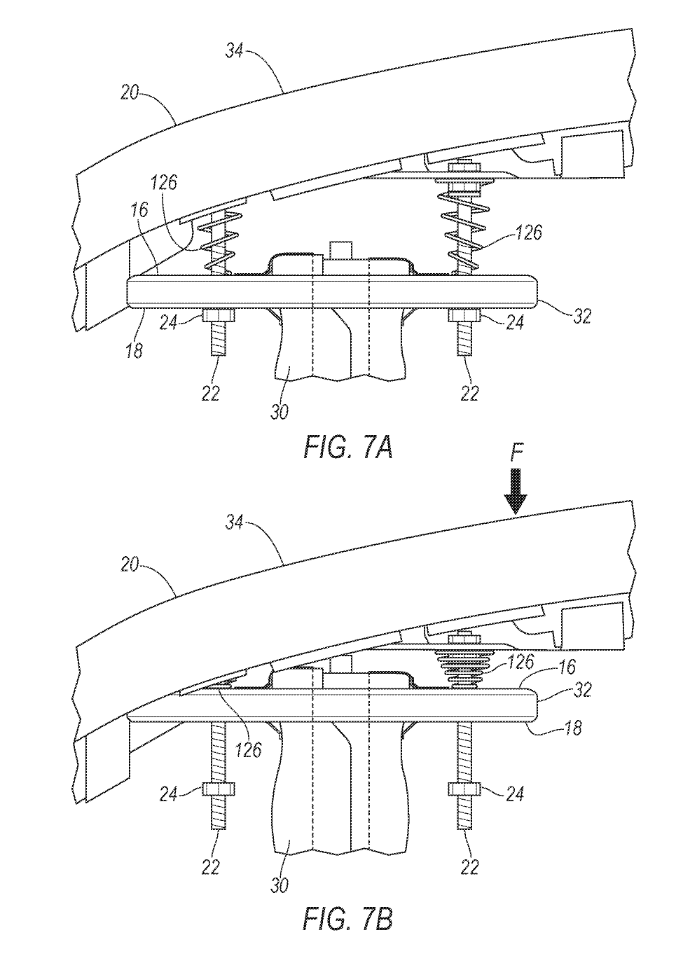

The spring 26, 126 urges the bumper 20 vehicle forward with the head 24 retaining the rod 22 to the frame-rail end 14. The spring 26, 126 absorbs energy during certain vehicle impacts such as, for example, pedestrian impacts. For example, during a pedestrian impact, the bumper 20 moves toward the frame-rail end 14 against the bias of the spring 26, 126 to absorb energy from the impact and reduce energy delivered from the bumper 20 to the pedestrian. Specifically, the bumper 20 move from an extended position, as shown in FIGS. 5A and 7A, to a compressed position, as shown in FIG. 5B and 7B, when impacted by force sufficient to compress the spring 26, 126. Since the spring 26, 126 has a progressive non-linear spring rate, the force to displace the bumper 20 vehicle rearward increases with displacement. Accordingly, the force absorption is softer at lower speeds and increases as force increases. In some examples, the bumper 20 is resettable after impact. In such examples, after force on the bumper 20 is removed, the spring 26, 126 returns to the extended position.

The bumper 20, as an example, may impact the knee of a pedestrian impact test leg form during a standardized test. The leg form may be a flexible pedestrian leg impactor (Flex-PLI) leg form. Example regulations that can use the leg form include Global Technical Regulation (GTR), ECE R127 and Korean Motor Vehicle 10 Safety Standards (KMVSS). Example new car assessment programs that can use the leg form include EuroNCAP, CNCAP, and ANCAP. In a frontal impact test, the bumper 20 may impacts a fixed barrier, e.g., impact with a fixed barrier at 35 mph during a NHTSA test.

The vehicle 10 may be any suitable type of automobile, e.g., a passenger or commercial automobile such as a sedan, a coupe, a truck, a sport utility vehicle, a crossover vehicle, a van, a minivan, a taxi, a bus, etc. The vehicle 10, as an example, may have a relatively high ride height.

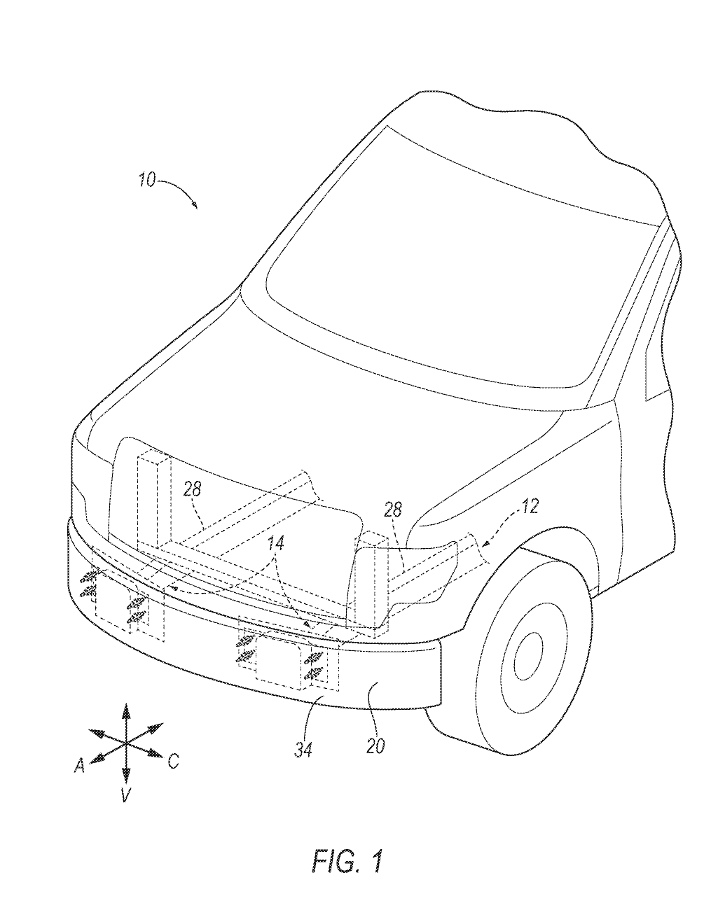

With reference to FIG. 1, the vehicle 10 defines a vehicle-longitudinal axis L extending between a front end (not numbered) and a rear-end (not numbered) of the vehicle 10. The vehicle 10 defines a vehicle-lateral axis A extending cross-vehicle from one side to the other side of the vehicle 10. The vehicle 10 defines a vertical axis V. The vehicle-longitudinal axis L, the vehicle-lateral axis A, and the vertical axis V are perpendicular relative to each other.

The vehicle 10 includes the vehicle frame 12 and a vehicle body. The vehicle body and the vehicle frame 12 may have a body-on-frame construction (also referred to as a cab-on-frame construction) in which the vehicle body and vehicle frame 12 are separate components, i.e., are modular, and the vehicle body is supported on and affixed to the vehicle frame 12. In the example shown in the Figures, the vehicle 10 has a body-on-frame construction. As another example, the vehicle body and the vehicle frame 12 may be of a unibody construction in which the vehicle frame 12 is unitary with the vehicle body (including frame rails 28, pillars, roof rails, etc.). Alternatively, the vehicle frame 12 and vehicle body may have any suitable construction. The vehicle frame 12 and vehicle body may be of any suitable material, for example, steel, aluminum, and/or fiber-reinforced plastic, etc.

The vehicle body includes body panels. The body panels may include structural panels, e.g., rockers, pillars, roof rails, etc. The body panels may include exterior panels. The exterior panels may present a class-A surface, e.g., a finished surface exposed to view by a customer and free of unaesthetic blemishes and defects. The body panels include, e.g., a roof panels, doors, fenders, hood, decklid, etc. The vehicle body may define a passenger cabin to house occupants, if any, of the vehicle 10.

The vehicle frame 12 includes frame rails 28 and may include cross beams. The frame rails 28 are elongated along the vehicle-longitudinal axis A. The frame rails 28 are spaced from each other cross-vehicle. The cross beams of the vehicle frame 12 extend from one frame rail 28 to the other frame rail 28 transverse to the vehicle-longitudinal axis A.

The vehicle frame 12 includes two frame rails 28. The frame rails 28 may define the cross-vehicle boundaries of the vehicle frame 12. The frame rails 28 may be elongated along the vehicle-longitudinal axis A from a rear end of the vehicle 10 to a front end of the vehicle 10. For example, the frame rails 28 may extend along substantially the entire length of the vehicle 10. In other examples, the frame rails 28 may be segmented and extend under portions of the vehicle 10, e.g., at least extending from below a passenger compartment of the vehicle 10 to the front end of the vehicle 10. In some examples, each frame rails 28 may be unitary from the rear end of the vehicle 10 to the front end of the vehicle 10. In other examples, the frame rails 28 may include segments fixed to each other (e.g., by welding, threaded fastener, etc.) and in combination extending from a rear end of the vehicle 10 to the front end of the vehicle 10.

As set forth above, the vehicle frame 12 may have a body-on-frame construction in which the vehicle body is supported on and affixed to the vehicle frame 12. In such an example, the frame rails 28 may include cab mount brackets (not shown) on which the vehicle body is supported and affixed. The cab mount brackets are fixed to the frame rails 28, e.g., welded to the frame rails 28. The cab mount brackets may extend outboard from the frame rail 28. The cab mount bracket may be cantilevered from the frame rail 28. The cab mount brackets are configured to support the vehicle body in a body-on-frame configuration. For example, the cab mount bracket may include a post or a hole that receives a hole or a post, respectively, of the vehicle body to connect the vehicle body to the vehicle frame 12. Specifically, the vehicle body may be fixed to the cab mount bracket. During assembly of the vehicle 10, the vehicle body is set on the vehicle frame 12 with fastening features of the vehicle body aligned with the cab mount brackets for engagement with the cab mount brackets.

The vehicle frame 12 may include suspension and steering attachment points (not shown) that support suspension and steering components of the vehicle 10. As one example, the suspension and steering attachment points may be suspension towers. Suspension and steering components of the vehicle 10 are connected to the vehicle frame 12, at least in part, at the suspension towers. The suspension and steering components include suspension shocks, suspension struts, steering arms, steering knuckles, vehicle 10 wheels, etc.

The vehicle frame 12 may have a powertrain compartment designed to support and house a vehicle 10 powertrain between the frame rails 28. For example, at least one of the cross-beams of the vehicle frame 12 may be a powertrain cradle, i.e., a cross-beam designed to support and affix to the vehicle 10 powertrain. The powertrain cradle may define a boundary of the powertrain compartment, e.g., a lower boundary of the powertrain compartment. The vehicle 10 powertrain in the powertrain compartment may be, for example, an internal combustion engine and a transmission, in which case the powertrain cradle is an engine cradle. In other examples, the vehicle frame 12, e.g., the frame rails 28 and/or the cross beams, are designed to support battery assemblies. The battery assembly may be of any suitable type for vehicular electrification to power propulsion of the vehicle 10, for example, lithium-ion batteries, nickel-metal hydride batteries, lead-acid batteries, or ultracapacitors, as used in, for example, plug-in hybrid electric vehicle 10s (PHEVs), hybrid electric vehicle 10s (HEVs), or battery electric vehicle 10s (BEVs).

The frame rails 28 and cross-beams may be extruded, roll-formed, etc. The frame rails 28 and cross-beams of the vehicle frame 12 may be of any suitable material, e.g., suitable types of steel, aluminum, and/or fiber-reinforced plastic, etc. The frame rails 28 and cross-beams may be hollow. The frame rails 28 and cross-beams may be rectangular in cross-section (e.g., a hollow rectangular cuboid), round in cross section, e.g., a hollow, round such as a hollow cylinder), etc.

The vehicle frame 12 includes the frame-rail ends 14 extending vehicle-forward of the frame rails 28, respectively. In other words, the vehicle frame 12 includes two frame-rail ends 14 with one frame-rail end 14 extending vehicle-forward of one of the frame rails 28 and the other frame-rail end 14 extending vehicle-forward of the other frame rail 28.

The frame-rail end 14 is fixed the respective frame rail 28. For example, the frame-rail end 14 may be fixed to the respective frame rail 28 by welding, fastening, etc. In the example shown in the Figures, the frame-rail end 14 is a component of the vehicle frame 12 that has a body-on-frame architecture, as described above. In other examples, the vehicle frame 12 may be of another architecture, e.g., a unibody architecture. In such examples, the frame rail 28 is a component of the vehicle frame 12 that has a unibody architecture and the frame-rail end 14 is connected to such frame rail 28.

The frame-rail end 14 is elongated along the vehicle-longitudinal axis A. For example, the frame-rail end 14 may be coaxial with the frame rail 28 at the connection of the frame-rail end 14 and the frame rail 28. The frame rail 28 has a vehicle-forward end and the frame-rail end 14 extends vehicle-forward from the vehicle-forward end of the frame rail 28. Specifically, the frame-rail end 14 has a vehicle-rearward end at the frame rail 28 and a vehicle-forward end at the springs 26, 126, as described further below.

The frame-rail end 14 includes a base 30 elongated along a vehicle-longitudinal axis A and a flange 32 extending radially from the base 30. The base 30 may include the vehicle-rearward end of the frame-rail end 14. The flange 32 may be at a vehicle-forward end of the frame-rail end 14, as shown in the example shown in the Figures.

The vehicle-forward face 16 faces in the vehicle-forward direction. The vehicle-forward face 16 may be planar, as shown in the example in the Figures. As set forth below, the spring 26, 126 abuts the flange 32 at the vehicle-forward face 16 of the frame-rail end 14. The vehicle-forward face 16 of the flange 32 is at the vehicle-forward end of the frame-rail end 14 in the example shown in the Figures.

The frame-rail end 14 includes a bore at the vehicle-forward end of the frame-rail end 14. The bore extends through the vehicle-forward end of the frame-rail end 14. In other words, the bore is open at the vehicle-forward end of the frame rail 28. The bore may extend continuously through the frame-rail end 14 through both the vehicle-forward end and the vehicle-rearward end of the frame rail 28. The bore is elongated along the vehicle-longitudinal axis A. The frame-rail end 14 may be extruded, roll-formed, etc. The frame-rail end 14 may be of any suitable material, e.g., suitable types of steel, aluminum, and/or fiber-reinforced plastic, etc. The frame-rail end 14 may be hollow, i.e., the bore makes the frame-rail end 14 hollow. The frame rails 28 and cross-beams may be rectangular in cross-section (e.g., a hollow rectangular cuboid), round in cross section, e.g., a hollow, round such as a hollow cylinder), etc.

The frame-rail ends 14 are designed to deform relative to the frame rail 28 during frontal-vehicle impact. Specifically, the frame-rail ends 14 deform vehicle-rearward to allow rearward movement of the bumper 20 assembly relative to the frame rails 28 to absorb energy during certain vehicle impacts. The frame-rail ends 14 may include features that direct deformation of the frame-rail end 14 toward the frame rail 28 during frontal impact of the bumper 20. These features may include wall geometry, wall thickness, dimples, cutouts, etc. The frame-rail ends 14 may be referred to in industry as crush cans.

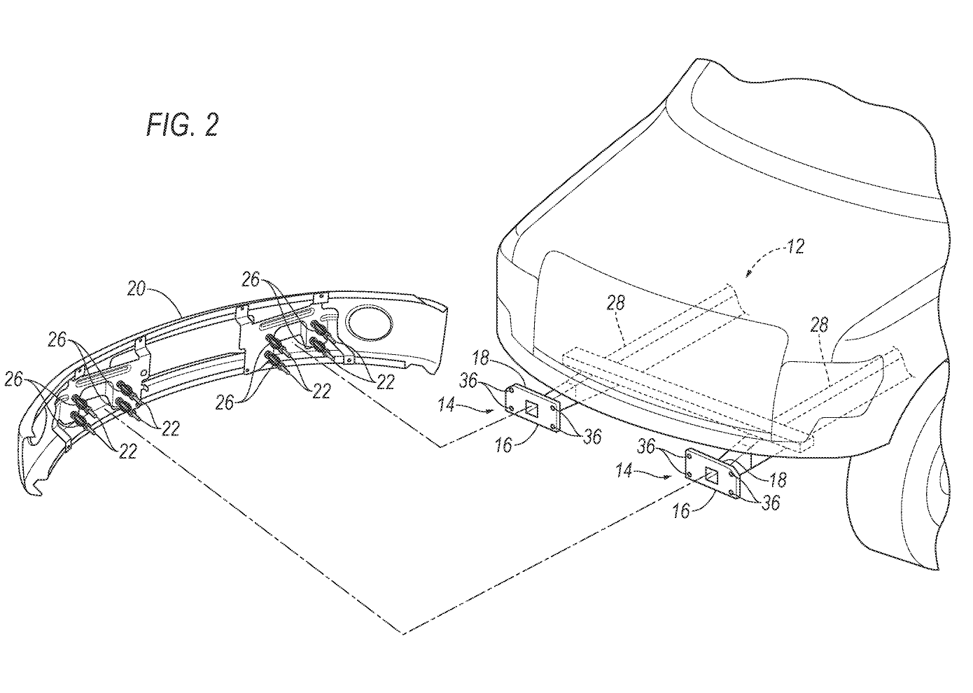

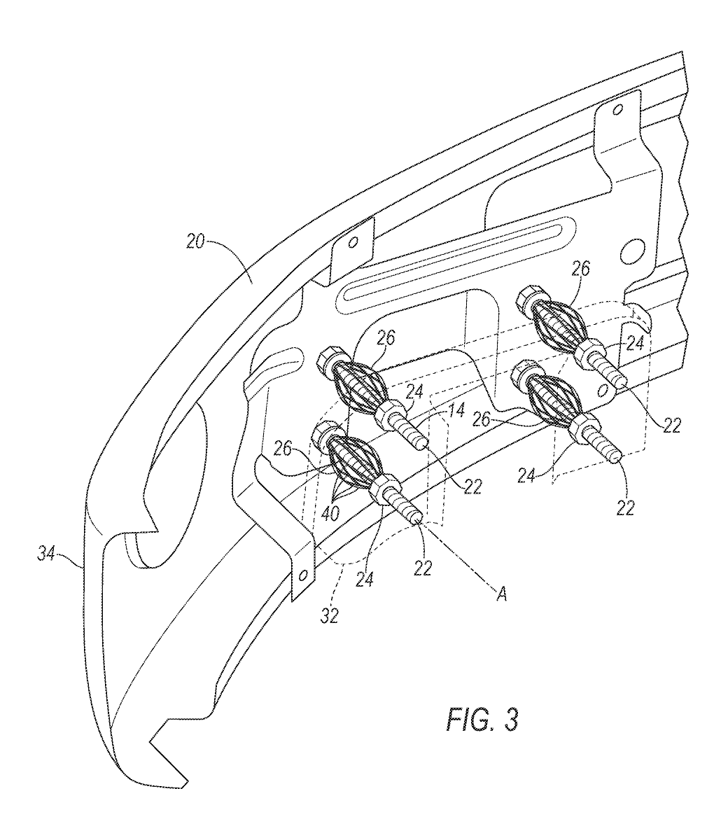

With reference to FIGS. 1-3, the vehicle 10 has a front-end structure. The front-end structure includes a grill and the bumper. The grill is above the bumper 20. The grill may be a component of the vehicle body and may be supported on other components of the vehicle body.

The bumper 20 is connected to the vehicle frame 12. Specifically, the bumper 20 is connected to the frame-rail ends 14 with the rods 22, as described further below.

The bumper 20 extends transversely to the frame rails 28, e.g., in a cross-vehicle direction C. With reference to FIGS. 1-3, the bumper 20 is elongated along the cross-vehicle direction C. The bumper 20 is supported by the vehicle frame 12, i.e., the weight of the bumper 20 is borne by the vehicle frame 12. The bumper 20 may be a front bumper, as shown in the Figures. In other words, the bumper 20 assembly may be at a front of the vehicle 10 and, in such examples, the bumper 20 is operable for frontal collisions of the vehicle 10.

The bumper 20 has a vehicle-forward surface 34. The vehicle-forward surface 34 may be a class-A surface, i.e., a surface specifically manufactured to have a high-quality, finished aesthetic appearance free of blemishes. In some examples, the class-A surface of the vehicle-forward surface 34 of the bumper 20 may be chromed. The bumper 20 may be of any suitable material such as metal (steel, aluminum, etc.), fiber-reinforced plastic, etc.

The bumper 20 includes at least one rod 22 and corresponding spring 26, 126. In the example shown in the Figures, the bumper 20 includes four rods 22 and springs 26, 126 at each frame-rail end 14. The energy absorbing assemblies support the bumper 20 at the vehicle-forward end of the frame-rail end 14.

The rod 22 is moveable with the bumper 20 relative to the frame-rail end 14 between the extended position and the compressed position. Specifically, as described below, the bumper 20 and the rod 22 move as a unit relative to the frame-rail end 14 between the extended position and the compressed position. The rods 22 support the bumper 20 on the frame-rail end 14, i.e., the weight of the bumper 20 is borne by the frame-rail end 14 through the rods 22.

The rods 22 are elongated along the vehicle-longitudinal axis A from the bumper 20 to the flange 32. The rods 22 extend through the flange 32, as described further below. The rods 22 are fixed to the bumper 20. Specifically, an end of the rod 22 may be fixed to the bumper 20 by, for example, welding or threaded engagement (e.g., threaded engagement with a weld nut fixed to the bumper 20). The bumper 20 may have a bracket on the vehicle-rearward side of the bumper 20, as shown in the example in the Figures, and the rods 22 may be fixed to the bracket. In such examples, the bracket may be fixed relative to the class-A vehicle-forward surface 34 of the bumper 20. The rods 22 may be, for example, metal. The rods 22 are rigid so that the rods 22 move with the bumper 20 relative to the flange 32 when the springs 26, 126 are compressed, as described further below.

The rods 22 slidably extend through the flange 32 as the rod 22 strokes between the extended position and the compressed position. The rods 22 extend through the vehicle-forward face 16 and the vehicle-rearward face 18 of the frame-rail end 14. The flange 32 includes rod hole 36 and the rods 22 extend through the rod hole 36 through a vehicle-forward face 16 and a vehicle-rearward face 18 of the flange 32. A head 24 on the rod 22 retains the rod 22 in the rod hole 36. Specifically, the head 24 abuts the vehicle-rearward face 18 of the flange 32 and the rod 22 extends from the head 24 vehicle-forward through the flange 32. The head 24 and the rod 22 may be non-unitary, i.e., formed separately and subsequently assembled, e.g., a nut engaged by threaded engagement (such as a lock nut, pinned nut, etc.), etc. As another example, the head 24 may be unitary with the rod 22. In other words, the head 24 and the rod 22 may be a single, uniform piece of material with no seams, joints, fasteners, or adhesives holding them together, i.e., formed together simultaneously as a single continuous unit, e.g., by machining from a unitary blank, molding, forging, casting, etc.

The head 24 is retained vehicle rearward of the vehicle-rearward face 18 by the frame-rail end 14. In the example shown in the Figures, the outer diameter of the head 24 is greater than the diameter of the rod hole 36 such that the head 24 is retained vehicle rearward of the vehicle-rearward face 18 of the flange 32. The head 24 may abut the vehicle-rearward face 18 of the flange 32 against the bias of the spring 26, 126 when the bumper 20 is in the extended position. When the bumper 20 is impacted with sufficient force to compress the spring 26, 126, the rod 22 and the head 24 move vehicle rearward as the spring 26, 126 compresses. Specifically, as the head 24 moves vehicle-rearward, the head 24 moves vehicle-rearward relative to the vehicle-rearward face 18 of the flange 32. When force is released from the bumper 20, the springs 26, 126 extend to move the head 24 toward the vehicle-rearward face 18 of the flange 32 until the bumper 20 reaches the extended position, e.g., when the head 24 abuts the vehicle-rearward face 18 of the flange 32 in the extended position.

The spring 26, 126 is between the flange 32 and the bumper 20. Specifically, the spring 26, 126 may abut the flange 32 and the bumper 20, e.g., the bracket of the bumper 20, in both the extended position and the compressed position of the resettable energy absorber. The spring 26, 126 biases the bumper 20 vehicle-forward relative to the flange 32. Specifically, the spring 26, 126 uses the flange 32 as a reaction surface to bias the bumper 20 vehicle-forward. The head 24 on the rod 22 retains the resettable energy absorber and the bumper 20 in the extended position in the absence of force on the bumper 20 sufficient to compress the spring 26, 126. The spring 26, 126 is resiliently compressible between the flange 32 and the bumper 20. In other words, the spring 26, 126 is compressed when forces on the bumper 20 exceed a force sufficient to compress the spring 26, 126 and, when the force is removed from the bumper 20, the spring 26, 126 returns to its pre-compressed state. Specifically, in the extended position, the spring 26, 126 biases the bumper 20 vehicle-forward to abut the head 24 against the vehicle-rearward face 18 of the flange 32. When force on the bumper 20 exceeds a threshold to compress the spring 26, 126, the spring 26, 126 is compressed allowing the bumper 20 to move vehicle-rearward relative to the flange 32 and the head 24 moves vehicle-rearward relative to the flange 32. When the force is removed from the bumper 20, in some examples (e.g., pedestrian impact), the spring 26, 126 biases the bumper 20 vehicle-forward and returns the head 24 to abut the vehicle-rearward face 18. In other words, in some examples (e.g., pedestrian impact), the spring 26, 126 is resiliently compressible between the frame-rail end 14 and the bumper 20.

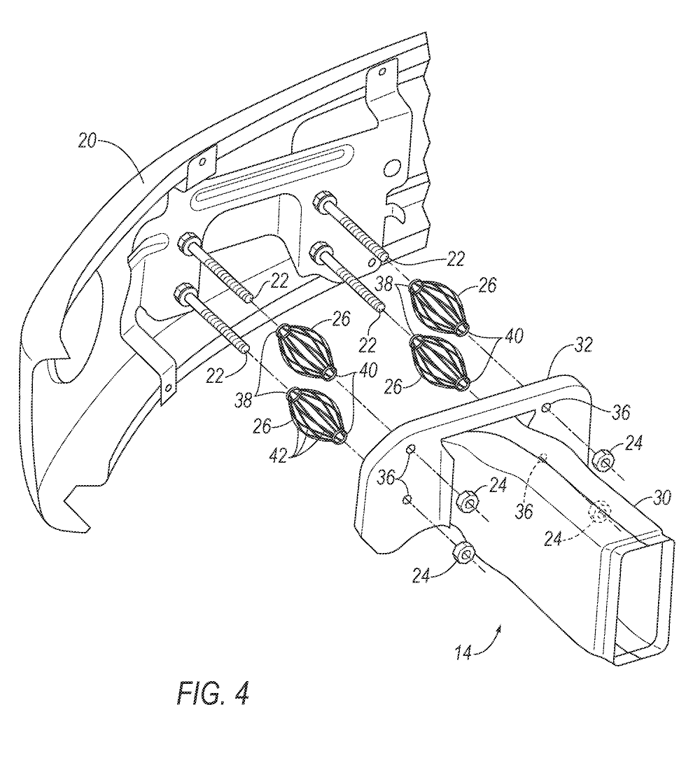

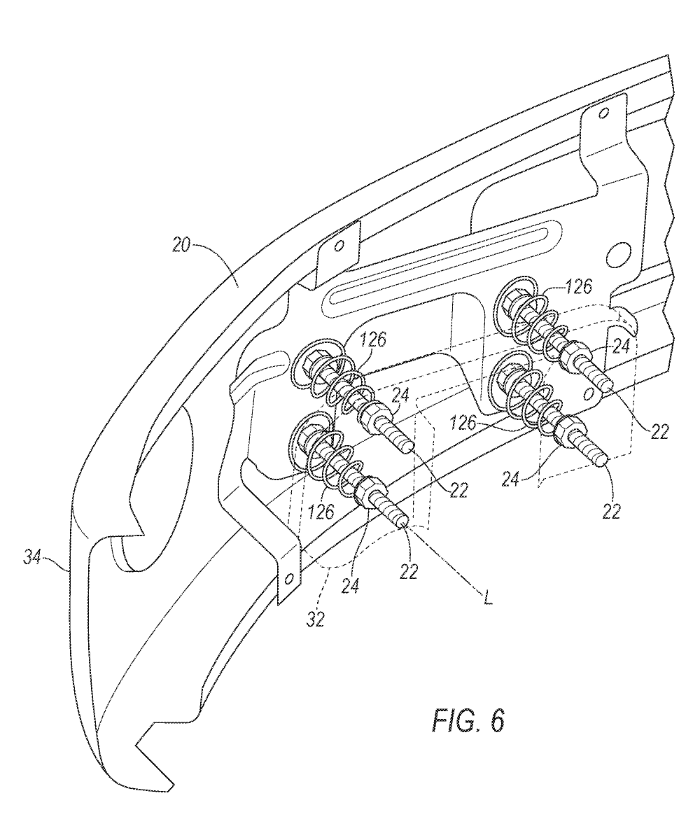

One example of the spring 26 is shown in FIGS. 1-5B and another example of the spring 126 is shown in FIGS. 6-7B. In both examples, the spring 26, 126 may be on the rod 22 between the bumper 20 and the flange 32, as shown in the Figures. In other words, the rod 22 extends through the spring 26, 126 between the bumper 20 and the flange 32.

In the examples shown in FIGS. 1-7B, the spring 26, 126 is loaded between the vehicle frame 12 and the bumper 20 in the extended position. In other words, the spring 26, 126 is partially compressed in the extended position so that the spring 26, 126 biases the bumper 20 in the extended position, e.g., with the head 24 abutting the vehicle-rearward face 18 of the flange 32 in the examples shown in the Figures. Since the spring 26, 126 is loaded in the extended position, the spring 26, 126 resists axial movement of the rod 22 relative to the flange 32 during operation of the vehicle 10 in the absence of forces on the bumper 20 of a magnitude associated with a vehicle impact such as a pedestrian impact, frontal-vehicle impact, etc.

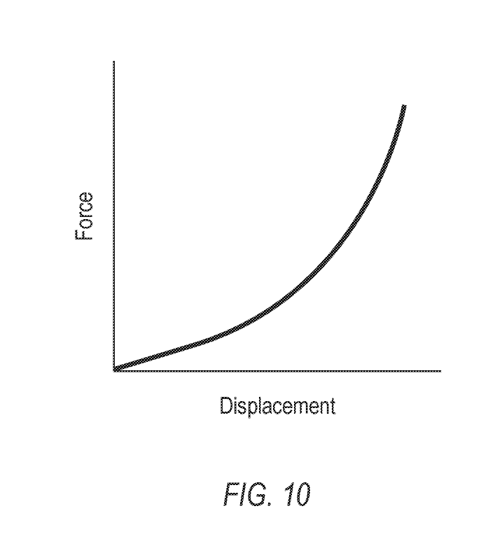

In the examples shown in FIGS. 1-7B, the spring 26, 126 has a progressive non-linear spring rate. The spring rate is the relationship between force on the spring 26, 126 and deflection of the spring 26, 126, which can be represented with a force-deflection curve. The force-deflection curve is non-linear. Specifically, since spring rate is progressive, the slope of the force-deflection curve increases. An example of the force-deflection curve for a progressive non-linear spring rate is shown in FIG. 10, and the spring 26 and/or spring 126 may have the force-deflection curve, or a similar curve, as that shown in FIG. 10 during movement of the bumper from the extended position to the compressed position.

In the example shown in FIGS. 1-5B, the spring 26 includes a front collar 38 engaged with the rod 22 adjacent the bumper 20, a rear collar 40 spaced from the rear collar 40 along an axis of the rod 22 and engaged with the rod 22 adjacent the frame-rail end 14, and a plurality of bows 42 extending from the front collar 38 to the rear collar 40 and fixed to the front collar 38 and the rear collar 40. In the extended position, the bows 42 are loaded in compression between the front collar 38 and the rear collar 40 to maintain the bumper 20 in the extended position in the absence of force on the bumper 20. Upon application of force to the bumper 20 that overcomes the force of the spring 26, e.g., force from a pedestrian impact or a frontal-vehicle impact, the bows 42 flex outwardly as the rod 22 moves rearward relative to the flange 32 through the rod hole 36. In both examples shown in the Figures, the spring 26 may be metal or any other suitable material.

The bows 42 may be designed to resiliently flex. For example, the bows 42 may resiliently flex when compressed under certain forces, e.g., forces associated with a pedestrian impact. In some examples, including the example shown in FIGS. 5A-5C, the bows 42 are designed (i.e., sized, shaped, positioned, material selection) to resiliently flex during a pedestrian impact test (as shown in FIG. 5B) and are designed to plastically deform during a full frontal impact test (as shown in FIG. 5C). Specifically, the bows 42 are designed to resilient flex when subjected to forces of magnitudes associated with pedestrian impact tests and to plastically deform when subjected to forces of magnitudes associated with full frontal impact tests. When resiliently deformed, the bows 42 deforms from an initial position under application of force and returns to the initial position when the force is removed. When plastically deformed, the bows 42 permanently deform. As examples, a pedestrian impact test may be of the type described above, and the full frontal impact test may be of the type described above.

The rod 22 extends through the spring 26. Specifically, in the example shown in the Figures, the front collar 38 and the rear collar 40 are endless around the rod 22 and the bows 42 are positioned circumferentially about the rod 22. The bows 42 are elongated along the axis L of the rod 22. In other words, the longest dimension of the bow 42 is along the axis L. The bows 42 arc outwardly away from the rod 22 between the front collar 38 and the rear collar 40. When force is applied to the front bumper 20 that overcomes the bias of the bows 42, the bows 42 flex further outwardly away from the rod 22.

The bows 42 are positioned circumferentially about the front collar 38 and the rear collar 40. The bows 42 are fixed to the front collar 38 and the rear collar 40. The ends of the bows 42 at the front collar 38 do not move relative to the front collar 38 and the ends of the bow 42 at the rear collar 40 do not move relative to the rear collar 40. In some examples, the bows 42 may be joined to the front collar 38 and/or the rear collar 40 by unitary formation (i.e., formation as a single unit by molding, machining from a blank, etc.), welding, adhesive, mechanical fastener, etc. In such examples, a mechanical joint between the bows 42 and the collars retain the bows 42 to the collars, including before assembly of the spring 26 to the rod 22. In other examples the front collar 38 and the rear collar 40 may clamp ends of the bows 42 between the collar and the rod 22. In such examples, the tension of the bows 42 against the collars 38, 40 due to the pre-loading of the spring 26 may retain the bows 42 in the collars 38, 40 without a joint between the bows 42 and the collar 38, 40.

In some examples, the front collar 38 is slidably engaged with the rod 22 and the rear collar 40 is slidably engaged with the rod 22. In such examples, the bows 42 push the front collar 38 toward the bumper 20 and push the rear collar 40 toward the flange 32. In some examples, the front collar 38 abuts the bumper 20 and/or the rear collar 40 abuts the frame-rail end 14, i.e., the front collar 38 is in direct contact with the bumper 20 and/or the rear collar 40 is in direct contact with the frame-rail end 14. For example, in the example shown in the Figures, the front collar 38 abuts the bumper 20 and the rear collar 40 abuts the flange 32 of the frame-rail end 14. For example, in the example shown in the Figures, the front collar 38 is cylindrical, the rear collar 40 is cylindrical, and the rod 22 is cylindrical. The front collar 38 and the rear collar 40 are sized to slide on the rod 22.

In the example in FIGS. 6-7B, the spring 126 is a conical coil spring. The outer diameter of the conical coil springs 126 progressively decrease from one end of the spring 126 to the other end of the spring 126. In other words, the conical spring 126 tapers from one end to the other end. In such an example, the tapered end of the conical spring 126 deforms more easily than the wider end of the conical spring 126, which results in the progressive non-linear spring rate of the conical coil spring 126. In some examples, the thickness of the wire of the spring 126 may increase from one end to the other end of the spring 126, e.g., from the tapered end to the wide end, to vary the progressive non-linear spring rate. In some examples, the coils of the conical coil spring 126 may have outer diameters sized so that the coils next within each other when the conical coil spring 126 is fully compressed.

The conical coil spring 126 may be coiled around the rod 22, as shown in the example in the Figures. One end of the conical coil spring 126 may abut the bumper 20 and the other end of the conical coil spring 126 may abut the flange 32 of the frame-rail end 14.

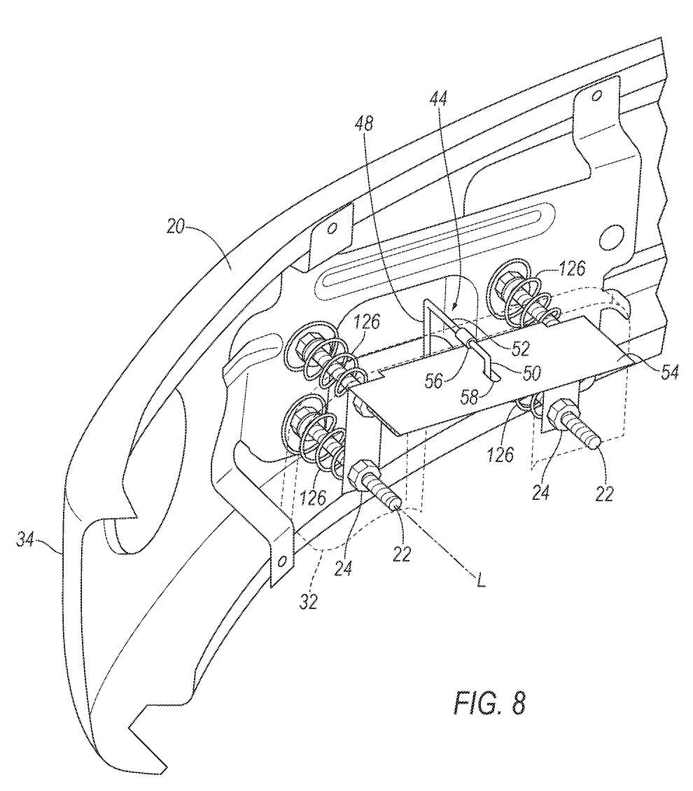

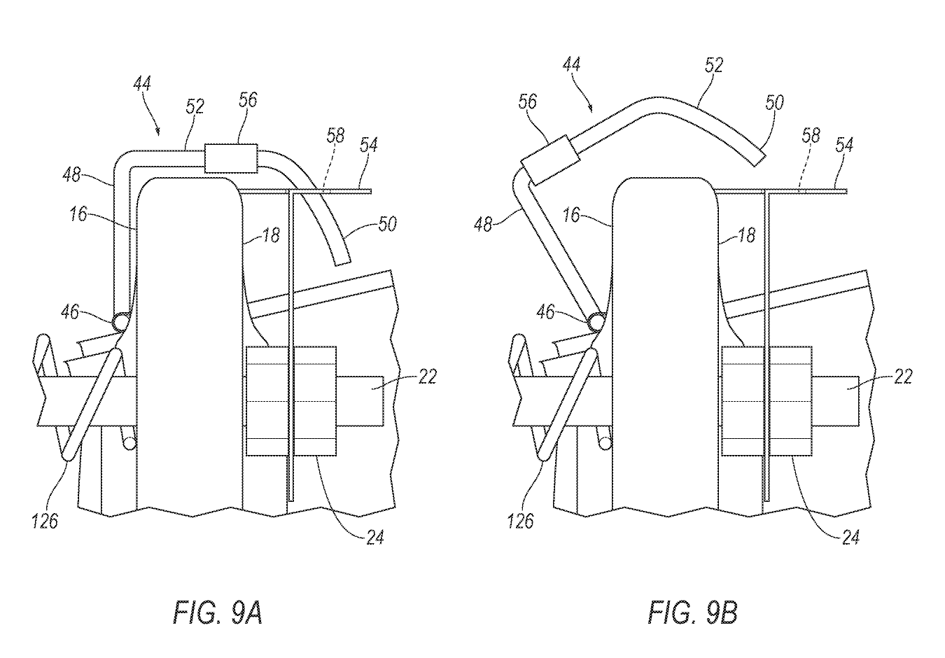

In the example shown in FIGS. 8-9B, a latch 44 may releasably connect the rod 22 with the frame-rail end 14. When the latch 44 connects the rod 22 and the frame-rail end 14, as shown in FIG. 9A, the latch 44 prevents relative movement of the bumper 20 relative to the frame-rail end 14 by preventing movement of the rod 22 relative to the frame-rail end 14. In the event of a vehicle impact, as shown in FIG. 9B, the latch 44 releases the rod 22 from the frame-rail end 14 and allows the rods 22 to stroke in the rod hole 36 so that the bumper 20 can move rearward relative to the frame-rail end 14. The example shown in FIGS. 8-9B show the conical coil spring 126, and in other examples, the latch 44 may be used with the spring 26 shown in FIGS. 1-5B.

The latch 44 is rotatably connected to the vehicle-forward face 16 of the frame-rail end 14. For example, the latch 44 may include a hinge 46 connected to the vehicle-forward face 16. The hinge 46 may be any suitable type of hinge including, for example, the pinned hinge shown in FIGS. 8-9B.

The latch 44 extends vehicle rearward to engage the rod 22 vehicle-rearward of the vehicle-rearward face 18. Specifically, the latch 44 includes a forward portion 48 rotatably connected to the vehicle-forward face 16, a rear portion 50 vehicle rearward of the vehicle-rearward face 18, an intermediate portion 52 extending from the forward portion 48 to the rear portion 50. In the example shown in FIGS. 8-9B, the latch 44 is generally U-shaped. The rear portion 50 may extend at a non-right angle vehicle rearward from the intermediate portion 52 to allow the latch 44 to clear the flange 32 as the latch 44 rotates from a locked position, as shown in FIG. 9A, to an unlocked position, as shown in FIG. 9B.

The latch 44 is releasably engaged with the rod 22 vehicle-rearward of the vehicle-rearward face 18. As an example, as shown in FIGS. 8-9B, a plate 54 may be fixed to the rod 22 (i.e., moveable as a unit with the rod 22), and the latch 44 may be releasably engaged with the plate 54. The plate 54, for example, may be sandwiched between a nut and the head 24, as shown in the example in FIGS. 8-9B. In such examples, the nut and the head 24 may be threadedly engaged with the rod 22.

The plate 54 may define a hole 58 that receives the rear portion 50 to selectively lock the rod 22 to the flange 32. The latch 44 may be inertia-driven from the locked position connecting the rod 22 with the frame-rail end 14 and the unlocked position disconnected from the rod 22 and/or the frame-rail end 14. Specifically, the latch 44 may be designed to rotate about the hinge 46 from the locked position to the unlocked position when subjected forces associated with a vehicle impact such as a pedestrian impact and/or a frontal vehicle impact, due to inertia of the latch 44. During impact, force on the bumper 20 rapidly decelerates the forward movement of the bumper 20, the frame-rail end 14, and the hinge 46 on the frame-rail end 14, and during this rapid deceleration, the inertia of the latch 44 forces the latch 44 to rotate about the hinge 46 to the unlocked position.

In the example shown in the Figures, a weight 56 may be on the intermediate portion to trigger the inertia-based rotation of the latch 44 about the hinge 46 in response to force associated with a vehicle impact. In other words, the weight 56 increases the moment of force about the hinge 46. In some examples, including the example shown in FIGS. 9A-B, the weight 56 may be slidably engaged with the intermediate portion 52. In such an example, the weight 56 is initially mounted on the intermediate portion 52 near the rear portion 50, and the weight 56 is slidable vehicle forward on the intermediate portion 52 when subjected to force associated with a vehicle impact. The vehicle-forward movement of the weight 56 on the intermediate portion 52 when subjected to forces associated with a vehicle impact triggers rotation of the latch 44 about the hinge 46.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle comprising:
a vehicle frame having a frame-rail end, the frame-rail end having a vehicle-forward face and a vehicle-rearward face;
a bumper vehicle-forward of the frame-rail end;
a rod supporting the bumper on the frame-rail end, the rod being fixed to the bumper and slidably extending through the vehicle-forward face and the vehicle-rearward face of the frame-rail end;
a head fixed to the rod and retained vehicle-rearward of the vehicle-rearward face by the frame-rail end; and
a spring on the rod, the spring having a progressive non-linear spring rate.

2. The vehicle as set forth in claim 1, wherein the bumper is moveable vehicle-rearward from an extended position toward the frame-rail end, the spring being loaded between the vehicle frame and the bumper in the extended position.

3. The vehicle as set forth in claim 2, wherein the spring is resiliently compressible between the frame-rail end and the bumper.

4. The vehicle as set forth in claim 1, wherein the spring includes a front collar engaged with the rod adjacent the bumper, a rear collar spaced from the rear collar along an axis of the rod and engaged with the rod adjacent the frame-rail end, and a plurality of bows extending from the front collar to the rear collar and fixed to the front collar and the rear collar.

5. The vehicle as set forth in claim 4, wherein the bows are elongated along the axis of the rod.

6. The vehicle as set forth in claim 4, wherein the front collar is slidably engaged with the rod and the rear collar is slidably engaged with the rod.

7. The vehicle as set forth in claim 6, wherein the front collar abuts the bumper and the rear collar abuts the frame-rail end.

8. The vehicle as set forth in claim 4, wherein the front collar is cylindrical and the rear collar is cylindrical, the bows being positioned circumferentially about the front collar and the rear collar.

9. The vehicle as set forth in claim 4, wherein the bows arc outwardly away from the rod between the front collar and the rear collar.

10. The vehicle as set forth in claim 4, wherein the bows are designed to resiliently flex during a pedestrian impact test, and the bows are designed to plastically deform during a frontal impact test.

11. The vehicle as set forth in claim 1, wherein the spring is a conical coil spring.

12. The vehicle as set forth in claim 11, wherein the conical coil spring is coiled around the rod.

13. The vehicle as set forth in claim 11, wherein the conical coil spring abuts the bumper and the frame-rail end.

14. The vehicle as set forth in claim 1, further comprising a latch releasably connecting the rod with the frame-rail end.

15. The vehicle as set forth in claim 14, wherein the latch is rotatably connected to the vehicle-forward face of the frame-rail end, the latch being releasably engaged with the rod vehicle-rearward of the vehicle-rearward face.

16. The vehicle as set forth in claim 14, wherein the latch includes a forward portion rotatably connected to the vehicle-forward face, a rear portion vehicle rearward of the vehicle-rearward face, an intermediate portion extending from the forward portion to the rear portion, and a weight slidable vehicle forward on the intermediate portion.

17. The vehicle as set forth in claim 14, further comprising a plate fixed to the rod and releasably engaged with the latch.

18. The vehicle as set forth in claim 14, wherein the latch is inertia-driven from a locked position connecting the rod with the frame-rail end and an unlocked position disconnected from the rod and/or the frame-rail end.

19. The vehicle as set forth in claim 1, wherein the frame-rail end includes a base elongated along a vehicle-longitudinal axis and a flange extending radially from the base, and the flange includes the vehicle-forward face and the vehicle-rearward face.
